(19) United States
(12) Patent Application Publication
(10) Pub. No.: US 2020/0140747 A1
(43) Pub. Date: May 7, 2020

(54) Compositions and Methods for Corrosion Inhibition

(71) Applicant: Halliburton Energy Services, Inc., Houston, TX (US)

(72) Inventor: Enrique Antonio Reyes, Tomball, TX (US)

(73) Assignee: Halliburton Energy Services, Inc., Houston, TX (US)

(21) Appl. No.: 16/344,918

(22) PCT Filed: Dec. 13, 2016
(86) PCT No.: PCT/US2016/066272

§ 371 Date: Apr. 25, 2019

(51) Int. Cl. C09K 8/74; C09K 8/54; E21B 43/26; E21B 41/02

(52) U.S. Cl. CPC C09K 8/74; C09K 8/54; C09K 2208/32; E21B 41/02; E21B 43/26

(57) ABSTRACT

The present disclosure generally relates to corrosion inhibition, and, more specifically, to corrosion inhibition in acidic treatment fluids. The treatment fluids may comprise an aqueous base fluid, an acid, a corrosion inhibitor, and a corrosion inhibitor intensifier. The corrosion inhibitor intensifier enhances the inhibitor corrosion action of a metal surface by the corrosion inhibitor at high temperatures. The corrosion inhibitor intensifier may be tetrahydrofurfuryl alcohol, tetrahydrofurfuryl amine, or any combination thereof.

### BACKGROUND

The present disclosure generally relates to corrosion inhibition, and, more specifically, to corrosion inhibition in acidic treatment fluids.

Treatment fluids may be used in a variety of subterranean treatment operations. Such treatment operations may include, without limitation, drilling operations, completion operations, stimulation operations, production operations, remediation operations, sand control treatment operations, and the like. As used herein, the term “treatment,” and grammatical equivalents thereof, refers to any subterranean operation that uses a fluid in conjunction with achieving a desired function and/or for a desired purpose. Use of these terms does not imply any particular action by the treatment fluid or a component thereof, unless otherwise specified herein. Illustrative treatment operations may include, for example, fracturing operations, gravel packing operations, acidizing operations, scale dissolution and removal operations, sand control operations, consolidation operations, and the like.

Acidizing and fracturing treatments using acidic treatment fluids commonly are carried out in hydrocarbon-containing subterranean formations penetrated by a well bore to accomplish a number of purposes, one of which is to increase the permeability of the formation. The increase in formation permeability normally results in an increase in the recovery of hydrocarbons therefrom. More particularly, the acidic treatment fluid reacts with and dissolves (or solubilizes) acid-soluble materials contained in the formation, resulting in an increase in the size of the pore spaces and an increase in the permeability of the formation. In fracture-acidizing treatments, one or more fractures are produced or enhanced in the formation, and the acidic treatment fluid is introduced into the fracture to etch flow channels in the fracture face. An acidic treatment fluid may also be used to remove acid-soluble precipitation damage that can be present in the formation. In other examples, acid-soluble materials that have been deliberately introduced into a formation may be dissolved with an acidic treatment fluid (e.g., acid-soluble proppant particulates, filter cake particulates), which may or may not increase production.

Illustrative examples of formation components that may be dissolved by an acid (e.g., in an acidic treatment fluid) may include, for example, metal carbonates, silicates, aluminosilicates, and certain metal oxides (e.g., magnesium oxide (MgO), calcium oxide (CaO), manganese oxide (Mn₃O₄), and the like), and the like. Illustrative uses of acidic treatment fluids during subterranean treatment operations may include, for example, matrix acidizing of siliceous and/or non-siliceous formations, scale dissolution and removal operations, gel breaking, acid fracturing, removal of drilling fluid filter cake, and the like. The acidic component of acidic treatment fluids can be especially corrosive to sensitive metallurgic grades, such as carbon steel (e.g., Q125, X65, and the like), chrome alloys (e.g., 13CR chrome, 25CR chrome). As used herein, the term “corrosion” refers to any reaction between a material and its environment that causes some deterioration of the material or its properties. Such corrosion may lead to buildup of corrosive byproducts (“scale”) which may be deposited on or coat perforations, casing, production tubulars, screens, valves, pumps, and downhole completion equipment, such as safety equipment and gas lift mandrels, resulting in a decrease in hydrocarbon production. If allowed to proceed, such scale buildup may eventually require abandonment of a well.

### BRIEF DESCRIPTION OF THE DRAWING

The following figures are included to illustrate certain aspects of the present disclosure and should not be viewed as an exclusive embodiment. The subject matter disclosed is capable of considerable modifications, alterations, combinations, and equivalents in form and function, as will occur to one having ordinary skill in the art and the benefit of this disclosure.

FIG. 1 depicts an embodiment of a system configured for delivering various treatment fluids of the embodiments described herein to a downhole location, according to one or more embodiments of the present disclosure.

FIG. 2 shows a photographic image of an Inconel 825 nickel alloy coupon that is representative of a metal surface type for corrosion inhibition using the treatment fluids described herein, according to one or more embodiments of the present disclosure.

FIG. 3 shows a photographic image of an Inconel 825 nickel alloy coupon after exposure to a treatment fluid comprising the corrosion inhibitor described herein for 24 hours, according to one or more embodiments of the present disclosure.

FIGS. 4A and 4B show two photographic images of an Inconel 825 nickel alloy coupon after exposure to a treatment fluid comprising the corrosion inhibitor described herein for 72 hours, according to one or more embodiments of the present disclosure.

FIG. 5 shows a photographic image of an NT-95 carbon steel alloy coupon after exposure to a treatment fluid comprising the corrosion inhibitor described herein for 72 hours, according to one or more embodiments of the present disclosure.

### DETAILED DESCRIPTION

The present disclosure generally relates to corrosion inhibition, and, more specifically, to corrosion inhibition in acidic treatment fluids.

One or more illustrative embodiments disclosed herein are presented below. Not all features of an actual implementation are described or shown in this application for the sake of clarity. It is understood that in the development of an actual embodiment incorporating the embodiments disclosed herein, numerous implementation-specific decisions must be made to achieve the developer's goals, such as compliance with system-related, lithology-related, business-related, government-related, and other constraints, which vary by implementation and from time to time. While a developer's efforts might be complex and time-consuming, such efforts would be, nevertheless, a routine undertaking for those of ordinary skill in the art having benefit of this disclosure.

It should be noted that when “about” is provided herein at the beginning of a numerical list, the term modifies each number of the numerical list. In some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, properties such as molecular weight, reaction conditions, and so forth used in the present specification and associated claims are to be understood as being modified in all instances by the term “about.” As used herein, the term “about” encompasses +/−5% of a numerical value. For example, if the numerical value is “about 5,” the range of 4.75 to 5.25 is encompassed. Accordingly, unless indicated to the contrary, the numerical parameters set forth in the following specification and attached claims are approximations that may vary depending upon the desired properties sought to be obtained by the exemplary embodiments described herein. At the very least, and not as an attempt to limit the application of the doctrine of equivalents to the scope of the claim, each numerical parameter should at least be construed in light of the number of reported significant digits and by applying ordinary rounding techniques.

While compositions and methods are described herein in terms of “comprising” various components or steps, the compositions and methods can also “consist essentially of” or “consist of” the various components and steps. When “comprising” is used in a claim, it is open-ended.

As used herein, the term “substantially” means largely, but not necessarily wholly.

The use of directional terms such as above, below, upper, lower, upward, downward, left, right, uphole, downhole and the like are used in relation to the illustrative embodiments as they are depicted in the figures herein, the upward direction being toward the top of the corresponding figure and the downward direction being toward the bottom of the corresponding figure, the uphole direction being toward the surface of the well and the downhole direction being toward the toe of the well. Additionally, the embodiments depicted in the figures herein are not necessarily to scale and certain features are shown in schematic form only or are exaggerated or minimized in scale in the interest of clarity.

Acidic treatment fluids represent a potential corrosion threat to many metal surfaces used in subterranean formation operations, such as completion operations having metal tubulars, screens, valves and other pumps, gas lift components, and the like. These metal surfaces may be composed of any metal or metal alloy (e.g., titanium, steel, iron, nickel, chromium, molybdenum, any alloys thereof (e.g., carbon steel, Inconel, 13CR chrome, 25CR chrome), and the like, and any combination thereof). Traditional corrosion inhibitors are operative with acidic treatment fluids comprising mineral acids, such as hydrofluoric acid, but are not effective or are less effective at high temperatures and/or over extended periods of time. As used herein, the terms “inhibit,” and grammatical variants thereof, refers to the lessening, reduction, or prevention of the tendency of a phenomenon (e.g., corrosion) to occur and/or the degree to which that phenomenon occurs. The term “inhibit,” and variants thereof, does not imply any particular extent or amount of suppression, unless otherwise specified herein.

Even less effective, if at all, are traditional corrosion inhibitors in the presence of organic acids, such as formic acid, particularly at high temperatures and/or extended periods of time. For example, no traditional or known corrosion inhibitors are effective at inhibiting corrosion in the presence of an organic acid (e.g., formic acid) for extended periods of time over about 8 hours at temperatures in excess of about 176.7° C. (equivalent to 250° F.). Moreover, no traditional or known corrosion inhibitors are effective at inhibiting corrosion in the presence of an organic acid (e.g., formic acid) for extended periods of time over about 8 hours at temperatures in excess of about 176.7° C. (equivalent to 250° F.) in the presence of a weighted brine, which itself is corrosive. As used herein, the term “weighted brine,” and grammatical variants thereof, refers to an aqueous fluid having a density greater than about 0.959 kilograms per liter (kg/L) (equivalent to about 8 pounds per gallon (lb/gal) and up to the solubility limit of at least one salt therein, encompassing any value and subset therebetween. In some embodiments, the weighted brine described herein is an aqueous fluid having a density in the range of about 0.959 kg/L to about 2.277 kg/L (equivalent to about 19 lb/gal) of one or more salt(s) therein, encompassing any value and subset therebetween.

The treatment fluids of the present disclosure provide effective corrosion inhibition in acidic treatment fluids at very high temperatures (e.g., even in excess of about 176.7° C. (350° F.), such as up to about 204.4° C. 400° F.) and/or over extended periods of exposure time (e.g., even in excess of 96 hours), and even in the presence of a weighted brine. As used herein, the term “high temperatures,” and grammatical variants thereof, with reference to use of the treatment fluids of the present disclosure refers to temperatures greater than about 125° C. (equivalent to about 257° F.), encompassing any value and subset thereof. In some embodiments, for example, the treatment fluids of present disclosure operate effectively at temperatures of greater than about 150° C. (equivalent to about 302° F.) to about 204.4° C. (equivalent to about 400° F.), encompassing any value and subset therebetween. A “high temperature subterranean formation” or “high temperature wellbore,” as used herein and grammatical variants thereof, refers to a formation, or wellbore of any trajectory (e.g., horizontal, vertical, deviated, and any combination thereof) in a formation, having the high temperatures defined above accordingly (i.e., temperatures greater than about 125° C. (equivalent to about 257° F.), encompassing any value and subset thereof). The treatment fluids described herein are effective immediately and continue to be effective over extended periods of time, including those in excess of 96 hours. Accordingly, although effective at lesser time periods, the terms “extended period of exposure time” or simply “extended period of time,” and grammatical variants thereof, as used herein with reference to the treatment fluids of the present disclosure, refer to time periods of greater than about 3 hours, encompassing any value and subset thereof. In some instances, the extended period of time is greater than about 3 hours to about 392 hours, about 72 hours to about 196 hours, or about 5 hours to about 24 hours, encompassing any value and subset therebetween. In some instances, the extended period of time is preferably greater than about 12 hours, encompassing any value and subset thereof, such as about 12 hours to about 392 hours.

The treatment fluids are accordingly effective in deep water wellbores and highly pressurized subterranean formations, where such temperatures and time requirements may be needed during an acidizing operation. As used herein, the terms “deep water wellbore” or “deep water well,” and grammatical variants thereof, refers to a wellbore of any trajectory (e.g., horizontal, vertical, deviated, and any combination thereof) having a subsea depth of about 1000 meters (m) to about 8000 m, encompassing any value and subset therebetween. The terms “highly pressurized” or “high pressure,” and grammatical variants thereof, as used herein, refers to a pressure of greater than about 13.79 megapascals (MPa), such as in the range of greater than about 14 MPa to about 55.16 MPa, encompassing any value and subset therebetween. A “highly pressurized” or “high pressure” subterranean formation or wellbore, as used herein, and grammatical variants thereof, refers to a formation, or wellbore of any trajectory (e.g., horizontal, vertical, deviated, and any combination thereof) in a formation, having the high pressures defined above accordingly. The treatment fluids described herein further are advantageously effective in the presence of organic acids, such as formic acid. Therefore, the embodiments described herein expand the ability of operator in the oil and gas field, or other industry fields that use acidic fluids in the presence of corrodible metals, to employ organic acids in acidizing treatment operations.

The treatment fluids described herein comprise at least an aqueous base fluid, an acid, a corrosion inhibitor, and a corrosion inhibitor intensifier. Unlike traditional corrosion intensifiers, the corrosion inhibitor intensifier is composed of a tetrahydrofurfuryl (“TFH”) alcohol or a tetrahydrofurfuryl (“THF”) amine (collectively “THFA corrosion intensifiers” or “THFA intensifiers”). Traditional corrosion inhibitor intensifiers employed in acidic fluids acidized with mineral acids include phosphates, halide salts (e.g., sodium, potassium), formic acid, and electrochemically active metals (e.g., antimony, bismuth, copper, tungsten, molybdenum, vanadium). These traditional corrosion inhibitor intensifiers operate by forming interfacial “bridges” between a steel surface and a corrosion inhibitor in solution, but are not effective under the conditions listed above (e.g., high temperatures, extended periods of time, in the presence of organic acids, in the presence of weighted brines). As described below, the THFA corrosion inhibitor intensifier of the present disclosure is effective under such conditions and operates by difference mechanisms than traditional corrosion inhibitor intensifiers.

The THFA corrosion inhibitor intensifier(s) (also referred to herein simply as “intensifier”) enhances surface corrosion inhibition of the corrosion inhibitor in the treatment fluid through the deposition of a coating on the surface of a metal (e.g., a metal located in a downhole environment, such as a tubular or a downhole tool). Without being bound by theory, in some instances, the coating may be such that it coats around the solubilized corrosion inhibitor and thereby allows enhanced contact between the metal surface and the corrosion inhibitor. Further, the THFA intensifier(s) is able to function as a co-solvent (in addition to the aqueous base fluid, which acts as the primary solvent) facilitating the dispersion of miscibility of the corrosion inhibitor in a treatment fluid, including a weighted brine. As described above, by these mechanisms, the THFA intensifier(s) intensifies the corrosion inhibitory action of the corrosion inhibitor(s) described herein in treatment fluids comprising organic acid(s) (e.g., formic acid, acetic acid, methanesulfonic acid, and the like). The THFA intensifier(s) further is able to enhance blending and miscibility of non-aqueous additives, as described below, into the aqueous base fluid treatment fluids of the present disclosure.

The effective functioning of the THFA intensifier(s) described herein is due to the reaction of the THFA compound in an acidic fluid (i.e., a treatment fluid comprising an acid, as provided herein) and at high temperatures. In particular, the THF alcohol and/or THF amine compound is able to undergo polymerization or film forming reactions under these conditions to be used as effective corrosion inhibitor intensifiers, to enable the coating (e.g., a thin coating) on a metal surface described above. Notably, the THFA intensifier(s) is not a resin, but a molecular species. As used here, the term “molecular species,” and grammatical variants thereof, refers to a tetrahydro-2-furanmethanol monomer.

The inclusion of the corrosion inhibitor intensifier described herein of THF alcohol and/or THF amine is capable of intensifying the inhibitory corrosion action of a metal surface by the corrosion inhibitor at high temperatures (e.g., in a high temperature subterranean formation) compared to the same composition without the specific corrosion inhibitor intensifier. In some embodiments, the THF alcohol intensifier may have the general chemical structure according to Structure I:

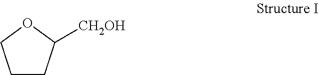

In some embodiments, the THF amine intensifier may have the general chemical structure according to Structure II:

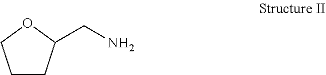

Advantageously, the THF alcohol intensifier, for example, is further environmentally friendly, biodegradable, is not classified as hazardous by the Environmental Protection Agency, and is not listed as a carcinogen. Accordingly, these properties ensure that the use of the THF alcohol intensifier in subterranean formation oil and gas operations, as described herein, are not hazardous to the environment or operators handling the compound and treatment fluids having the THF alcohol intensifier therein.

In some embodiments, the THFA corrosion inhibitor intensifier(s) may be present in the treatment fluids of the present disclosure in an amount of from about 1% to about 10% by volume of the treatment fluid composition, encompassing any value and subset therebetween. The particular amount of corrosion inhibitor intensifier may depend on a number of factors including, but not limited to, the temperature to which it is to be exposed, the desired duration of effectiveness, the metal surface in which corrosion inhibition is desired, the type and amount of the other components of the treatment fluid, and the like, and any combination thereof.

As described above, in addition to the THFA corrosion inhibitor intensifier(s), the treatment fluids of the present disclosure comprise at least an aqueous base fluid, an acid, and a corrosion inhibitor to be intensified.

As used herein, the term “aqueous base fluids” encompass both aqueous fluids and aqueous-miscible fluids. Suitable aqueous fluids for use as the aqueous base fluid described herein may include, but are not limited to, fresh water, saltwater (e.g., water containing one or more salts dissolved therein), brine (e.g., saturated salt water), produced water, treated wastewater, and any combination thereof. Suitable aqueous-miscible fluids for use as the aqueous base fluid of the treatment fluids of the present disclosure may include, but not be limited to, alcohols (e.g., methanol, ethanol, n-propanol, isopropanol, n-butanol, sec-butanol, isobutanol, and t-butanol), glycerins, glycols (e.g., polyglycols, propylene glycol, and ethylene glycol), polyglycol amines, polyols, any derivative thereof, any in combination with salts (e.g., sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, sodium carbonate, and potassium carbonate), any in combination with an aqueous-based fluid, and any combination thereof. The salts listed above may additionally be included in one, more, or all of the aqueous fluids.

Any of the above-referenced aqueous base fluids comprising dissolved salts, including any of those listed above with reference to the aqueous-miscible fluid which are equally applicable to the aqueous fluids, in accordance with the definition of a weighted brine, as defined above, are accordingly so defined. The corrosion inhibition of the treatment fluids described herein may be particularly effective in such weighted brines compared to traditional corrosion inhibitor intensifier compositions, and may further be more readily available (e.g., seawater may be more readily available than freshwater). Accordingly, the treatment fluids of the present disclosure are beneficially effective at corrosion inhibition even when the aqueous base fluid is such a weighted brine.

The acid for use in the treatment fluids described herein may be an organic acid. Any organic acid compatible with the components of the treatment fluid and suitable for use in a particular subterranean formation operation may be used in the embodiments described herein. Examples of suitable organic acids for use in the embodiments described herein may include, but are not limited to, formic acid, acetic acid, methanesulfonic acid, chloroacetic acid, dichloroacetic acid, trichloroacetic acid, fluoroacetic acid, difluoroacetic acid, trifluoroacetic acid, lactic acid, glutamic acid, malic acid, malonic acid, tartaric acid, gluconic acid, glycolic acid, stearic acid, and any combination thereof. The corrosion inhibitor and THFA intensifier(s) of the present disclosure are particularly effective in the presence of organic acids, such as formic acid, where traditional such compounds are ineffective or less effective under at least high temperature conditions.

The acid (i.e., an organic acid) may be included in an amount within the treatment fluids of the present disclosure to effectively acidize a formation, fracture face, or both a formation and fracture face to achieve the desired results (e.g., to etch channels or open pore spaces to enhance production). In some embodiments, the acid(s) is present in an amount of amount of from about 5% to about 40% by volume of the treatment fluid, encompassing any value and subset therebetween, such as from about 10% to about 25% by volume, or about 15% to about 20% by volume of the treatment fluid. The particular amount of acid may depend on a number of factors including, but not limited to, the type of formation being treated, the desired duration of effectiveness, the metal surface in which the acid may contact, the type and amount of the other components of the treatment fluid, and the like, and any combination thereof.

The corrosion inhibitor for use in the embodiments described herein may be any corrosion inhibitor compatible with the other components of a particular treatment fluid, including the THFA intensifier(s) and suitable for use in a subterranean formation operation. Examples of suitable corrosion inhibitors may include, but are not limited to, a quaternary ammonium compound, a sulfhydryl alkanoic acid (e.g., a thioglycolic acid), a bis-quaternary ammonium compound, an unsaturated carbonyl compound, 1-phenyl-1-ene-3-butanone, cinnamaldehyde, an unsaturated ether compound, 1-phenyl-3-methoxy-1-propene, an unsaturated alcohol, an acetylenic alcohol, a methyl butynol, methyl pentynol, hexynol, ethyl octynol, propargyl alcohol, benzylbutynol, ethynylcyclohexanol, a Mannich condensation product (e.g., products formed by reacting an aldehyde, a carbonyl containing compound, and a nitrogen containing compound), a condensation product formed by reacting an aldehyde in the presence of an amide, a polysaccharide, inulin, a tannin, tannic acid, catechin, epicatechin, epigallocatechin, epicatechingallate, formamide, a carbonyl source, an iodide, a quaternary derivative of a heterocyclic nitrogen base, a quaternary derivative of a halomethylated aromatic compound, a terpene, an aromatic hydrocarbon, coffee, tobacco, any derivatives thereof, and the like, and any combination thereof. As used herein, the term “derivative,” and grammatical variants thereof, refers to any compound that is made from one of the listed compounds, for example, by replacing one atom in one of the listed compounds with another atom or group of atoms, ionizing one of the listed compounds, or creating a salt of one of the listed compounds.

The corrosion inhibitor may be included in an amount within the treatment fluids of the present disclosure to effectively provide corrosion inhibition of a metal surface in combination with the corrosion inhibitor intensifier and the other components of the treatment fluids. In some embodiments, the corrosion inhibitor is present in an amount of from about 0.5% to about 5% by volume of the treatment fluid, encompassing any value and subset therebetween. For example, the corrosion inhibitor may be present in an amount of from about 1% to about 4.5%, or about 2% to about 4% by volume of the treatment fluid, encompassing any value and subset therebetween. The particular amount of corrosion inhibitor may depend on a number of factors including, but not limited to, the type of formation being treated, the desired duration of effectiveness, the metal surface in which the corrosion inhibitor may contact, the type and amount of the other components of the treatment fluid, and the like, and any combination thereof.

In some embodiments, the treatment fluids described herein may further include an additive such as, but not limited to, a salt, a weighting agent, an emulsifier, a non-emulsifier, a dispersion aid, a corrosion inhibitor, an emulsion thinner, a viscosifying agent, a clay inhibitor, a gelling agent, a surfactant, a foaming agent, a gas, a pH control additive, a breaker, a biocide, a crosslinker, a stabilizer, a chelating agent, a scale inhibitor, a gas hydrate inhibitor, a mutual solvent, an oxidizer, a reducer, a friction reducer, a clay stabilizing agent, an anti-sludging agent (i.e., to prevent acid sludge formation (and may also act as a non-emulsifier)), a diversion material, and any combination thereof.

In some embodiments, the present disclosure provides a method of introducing the treatment fluids of the present disclosure comprising at least an aqueous base fluid(s), an acid(s), a corrosion inhibitor(s), and a corrosion inhibitor intensifier(s) into a high temperature subterranean formation. The subterranean formation downhole or during the introduction of the treatment fluid through other components prior to reaching downhole (e.g., pumps, tubulars, valves, fittings, and the like) comprises a metal surface and the presence of the treatment fluid is able to inhibit corrosion thereof (i.e., lessen, reduce, or prevent corrosion of the metal surface). The treatment fluid may, for example, contact the metal surface and the corrosion inhibitor and corrosion inhibitor intensifier synergistically operate together, as described above, to inhibit corrosion of the metal surface. Further, as shown in the examples below, the corrosion inhibitor intensifier enhances inhibitory corrosion action of the metal surface by the corrosion inhibitor compared to inhibitory corrosion action of the metal surface by the corrosion inhibitor in the absence of the corrosion inhibitor intensifier. For example, the corrosion inhibitor intensifier functions as a co-solvent aiding in improving the miscibility of the corrosion inhibitor in the treatment fluid and/or may thinly coat the metal surface to facilitate coating and corrosion inhibition action by the corrosion inhibitor. In some embodiments, both the corrosion inhibitor and the corrosion inhibitor intensifier are coated onto (or about, such as surrounding) the metal surface to facilitate corrosion inhibition.

As described herein, the treatment fluids may have both the corrosion inhibitor and the corrosion inhibitor intensifier included therein. In other embodiments, one or more separate fluid streams may be introduced into a subterranean formation to perform a particular treatment operation where one has the corrosion inhibitor and the other has the corrosion inhibitor intensifier, without departing from the scope of the present disclosure. Such separate fluid streams may be introduced simultaneously, sequentially in any order, or alternatingly in any order. In preferred embodiments, whether the separate fluid streams are introduced separately or alternatingly, the fluid stream comprising the corrosion inhibitor is introduced first.

Although in some instances, the treatment fluids and method described herein may be with reference to a particular subterranean formation treatment operation, it will be appreciated that the treatment fluids described herein may be used in any subterranean formation treatment operation that may benefit from an acidic treatment fluid that also comprises enhanced corrosion inhibition, particularly under high temperatures. Examples of such subterranean formation treatment operations may include, but are not limited to, a drilling operation, a completion operation, a cementing operation, a stimulation operation, an acidizing operation, an acid-fracturing operation, a sand control operation, a fracturing operation, a frac-packing operation, a gravel-packing operation, a remedial operation, an enhanced oil recovery operation, and any combination thereof.

In various embodiments, systems configured for delivering the treatment fluids described herein to a downhole location are described. In various embodiments, the systems can comprise a pump fluidly coupled to a tubular, the tubular containing the treatment fluids described herein. It will be appreciated that while the system described below may be used for delivering any one of the treatment fluids described herein, each treatment fluid is delivered separately into the subterranean formation, unless otherwise indicated.

The pump may be a high pressure pump in some embodiments. As used herein, the term “high pressure pump” will refer to a pump that is capable of delivering a treatment fluid downhole at a pressure of 1000 psi or greater. A high pressure pump may be used when it is desired to introduce the treatment fluids to a subterranean formation at or above a fracture gradient of the subterranean formation, but it may also be used in cases where fracturing is not desired. In some embodiments, the high pressure pump may be capable of fluidly conveying particulate matter, such as the particulates described in some embodiments herein, into the subterranean formation. Suitable high pressure pumps will be known to one having ordinary skill in the art and may include, but are not limited to, floating piston pumps and positive displacement pumps.

In other embodiments, the pump may be a low pressure pump. As used herein, the term “low pressure pump” will refer to a pump that operates at a pressure of less than 1000 psi. In some embodiments, a low pressure pump may be fluidly coupled to a high pressure pump that is fluidly coupled to the tubular. That is, in such embodiments, the low pressure pump may be configured to convey the treatment fluids to the high pressure pump. In such embodiments, the low pressure pump may “step up” the pressure of the treatment fluids before reaching the high pressure pump.

In some embodiments, the systems described herein can further comprise a mixing tank that is upstream of the pump and in which the treatment fluids are formulated. In various embodiments, the pump (e.g., a low pressure pump, a high pressure pump, or a combination thereof) may convey the treatment fluids from the mixing tank or other source of the treatment fluids to the tubular. In other embodiments, however, the treatment fluids may be formulated offsite and transported to a worksite, in which case the treatment fluid may be introduced to the tubular via the pump directly from its shipping container (e.g., a truck, a railcar, a barge, or the like) or from a transport pipeline. In either case, the treatment fluids may be drawn into the pump, elevated to an appropriate pressure, and then introduced into the tubular for delivery downhole.

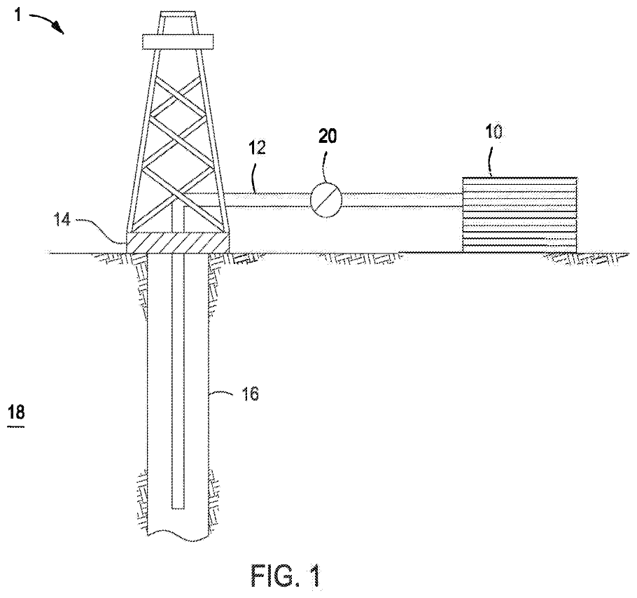

FIG. 1 shows an illustrative schematic of a system that can deliver the treatment fluids (i.e., the HVFF, the LVPadF, the LVPropF) of the present disclosure to a downhole location, according to one or more embodiments. It should be noted that while FIG. 1 generally depicts a land-based system, it is to be recognized that like systems may be operated in subsea locations as well (e.g., deep water wells). As depicted in FIG. 1, system 1 may include mixing tank 10, in which the treatment fluids of the embodiments herein may be formulated. The treatment fluids may be conveyed via line 12 to wellhead 14, where the treatment fluids enter tubular 16, tubular 16 extending from wellhead 14 into subterranean formation 18. Upon being ejected from tubular 16, the treatment fluids may subsequently penetrate into subterranean formation 18. Pump 20 may be configured to raise the pressure of the treatment fluids to a desired degree before introduction into tubular 16. It is to be recognized that system 1 is merely exemplary in nature and various additional components may be present that have not necessarily been depicted in FIG. 1 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 1, the treatment fluid or a portion thereof may, in some embodiments, flow back to wellhead 14 and exit subterranean formation 18. In some embodiments, the treatment fluid that has flowed back to wellhead 14 may subsequently be recovered and recirculated to subterranean formation 18, or otherwise treated for use in a subsequent subterranean operation or for use in another industry.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 1.

While various embodiments have been shown and described herein, modifications may be made by one skilled in the art without departing from the scope of the present disclosure. The embodiments described here are exemplary only, and are not intended to be limiting. Many variations, combinations, and modifications of the embodiments disclosed herein are possible and are within the scope of the disclosure. Accordingly, the scope of protection is not limited by the description set out above, but is defined by the claims which follow, that scope including all equivalents of the subject matter of the claims.

Embodiments disclosed herein include:

Embodiment A: A method comprising: introducing a treatment fluid into a high temperature subterranean formation, the treatment fluid comprising: an aqueous base fluid, an acid, a corrosion inhibitor, and a corrosion inhibitor intensifier selected from the group consisting of tetrahydrofurfuryl alcohol, tetrahydrofurfuryl amine, and any combination thereof; and inhibiting corrosion of a metal surface.

Embodiment B: A treatment fluid comprising: an aqueous base fluid; an acid; a corrosion inhibitor; and a corrosion inhibitor intensifier selected from the group consisting of tetrahydrofurfuryl alcohol, tetrahydrofurfuryl amine, and any combination thereof, wherein the corrosion inhibitor intensifier enhances inhibitory corrosion action of a metal surface by the corrosion inhibitor at a high temperature of greater than about 125° C. compared to inhibitory corrosion action of the metal surface by the corrosion inhibitor in the absence of the corrosion inhibitor intensifier at the high temperature.

Embodiment C: A system comprising: a tubular extending into a high temperature subterranean formation having a temperature of greater than about 125° C., and a pump fluidly coupled to the tubular, the tubular containing a treatment fluid comprising: an aqueous base fluid, an acid, a corrosion inhibitor, and a corrosion inhibitor intensifier selected from the group consisting of tetrahydrofurfuryl alcohol, tetrahydrofurfuryl amine, and any combination thereof, wherein the corrosion inhibitor intensifier enhances inhibitory corrosion action of a metal surface by the corrosion inhibitor compared to inhibitory corrosion action of the metal surface by the corrosion inhibitor in the absence of the corrosion inhibitor intensifier.

Embodiments A, B, and C may have one or more of the following additional elements in any combination:

Element 1: Wherein the corrosion inhibitor intensifier enhances inhibitory corrosion action of the metal surface by the corrosion inhibitor compared to inhibitory corrosion action of the metal surface by the corrosion inhibitor in the absence of the corrosion inhibitor intensifier.

Element 2: Further comprising coating the corrosion inhibitor and the corrosion inhibitor intensifier on a metal surface.

Element 3: Wherein the treatment fluid is introduced into a high temperature subterranean formation that has a temperature of from about 125° C. to about 204.4° C.

Element 4: Wherein the treatment fluid is introduced into a high temperature subterranean formation that is a deep water wellbore having a subsea depth of about 1000 meters (m) to about 8000 m.

Element 5: Wherein the treatment fluid is introduced into a high temperature subterranean formation that is a high pressure wellbore having a pressure of about 13.79 megapascals (MPa) to about 55.16 MPa.

Element 6: Wherein the acid is an organic acid.

Element 7: Wherein the corrosion inhibitor is selected from the group consisting of a quaternary ammonium compound, a sulfhydryl alkanoic acid (e.g., a thioglycolic acid), a bis-quaternary ammonium compound, an unsaturated carbonyl compound, 1-phenyl-1-ene-3-butanone, cinnamaldehyde, an unsaturated ether compound, 1-phenyl-3-methoxy-1-propene, an unsaturated alcohol, an acetylenic alcohol, a methyl butynol, methyl pentynol, hexynol, ethyl octynol, propargyl alcohol, benzylbutynol, ethynylcyclohexanol, a Mannich condensation product, a condensation product formed by reacting an aldehyde in the presence of an amide, a polysaccharide, inulin, a tannin, tannic acid, catechin, epicatechin, epigallocatechin, epicatechingallate, formamide, a carbonyl source, an iodide, a quaternary derivative of a heterocyclic nitrogen base, a quaternary derivative of a halomethylated aromatic compound, a terpene, an aromatic hydrocarbon, coffee, tobacco, any derivatives thereof, and any combination thereof.

Element 8: Wherein the acid is present in the treatment fluid in an amount of from about 5% to about 40% by volume of the treatment fluid.

Element 9: Wherein the corrosion inhibitor is present in the treatment fluid in an amount of about 0.5% to about 5% by volume of the treatment fluid.

Element 10: Wherein the corrosion inhibitor intensifier is present in the treatment fluid in an amount of about 1% to about 10% by volume of the treatment fluid.

By way of non-limiting example, exemplary combinations applicable to A, B, and C include: 1-10; 1, 2, and 8; 4 and 6; 7, 8, 9, and 10; 3, 4, and 7; 2, 5, and 9; 4 and 8; 1, 5, 6, and 10; and any non-limiting combination of two, more than two, or all of 1-10.

To facilitate a better understanding of the embodiments of the present disclosure, the following examples of preferred or representative embodiments are given. In no way should the following examples be read to limit, or to define, the scope of the present disclosure.

### EXAMPLE

In this example, the ability of the THFA intensifier described herein to enhance corrosion inhibition activity of a corrosion inhibitor in the presence of an acidic treatment fluid prepared according to the embodiments described herein was evaluated. The treatment fluids were evaluated based on their corrosion inhibition of a carbon steel, a 13CR chromium alloy, a 25CR chromium alloy, and an Inconel 825 nickel alloy in an acidic treatment fluid comprising formic acid. Typical corrosion inhibitors can be effective at lower temperatures and at periods of time of about 6-12 hours. This example demonstrates the effectiveness of the synergism between the corrosion inhibitor and the THFA corrosion inhibitor intensifier described herein at elevated temperature, over extended periods of time, and in a weighted brine.

Treatment Fluid Composition: Various Treatment Fluids (TF1, TF2, and TF3) were prepared in a weighted brine aqueous base fluid of fresh water with 1.643 kilograms per liter (kg/L) effective concentration (equivalent to 13.7 pounds per gallon (lbm/gal)) of calcium bromide salt in the presence of an acid of 15% by volume of formic acid. A combination of two corrosion inhibitors was used of a quaternary ammonium compound blend (CI-Q) and a sulfur-containing thioglycolic acid blend (CI-S) and the corrosion inhibitor intensifier was THF alcohol (CII-THFA), according to the formulations shown in Table 1 below. The “%” shown in Table 1 is % by volume of the treatment fluid (accounting for the liquid portion thereof).

TABLE 1

| | CI-Q | CI-S | CII-THFA |
|---|---|---|---|
| TF1 | 2% | 2% | 0% |
| TF2 | 2% | 2% | 3% |
| TF3 | 1% | 1% | 5% |

Each of TF1, TF2, and TF3 were prepared by first mixing the weighted brine aqueous base fluid and the formic acid, followed by continuous stirring during introduction of the CI-Q, CI-S, and CII-THFA (when included). Due to the presence of the CII-THFA in TF2 and TF3, the CII-THFA acted as a co-solvent in the presence of the weighted brine aqueous base fluid and formic acid, and thus mixing of the CI-Q and CI-S was facile. It was visibly observed in TF1 (having no CII-THFA) that miscibility of the CI-Q and CI-S was not obtained and separation and droplet aggregation was observed.

Corrosion Testing on Inconel 825: Each of TF1, TF2, and TF3 were exposed to a coupon of Inconel 825 nickel alloy over a period of time at 350° F. (176.7° C.) and the corrosion loss in pounds per square foot (lb/ft²) (converted to kilograms per square meter (kg/m²) below) was determined based on mass loss. The results are shown in Table 2 below.

TABLE 2

| | Exposure Time | Corrosion Loss |
|---|---|---|
| TF1 | 24 | 0.017 lb/ft² |
| | | (0.083 kg/m²) |
| TF2 | 24 | 0.017 lb/ft² |
| | | (0.083 kg/m²) |
| TF3 | 72 | 0.021 lb/ft² |
| | | (0.1025 kg/m²) |

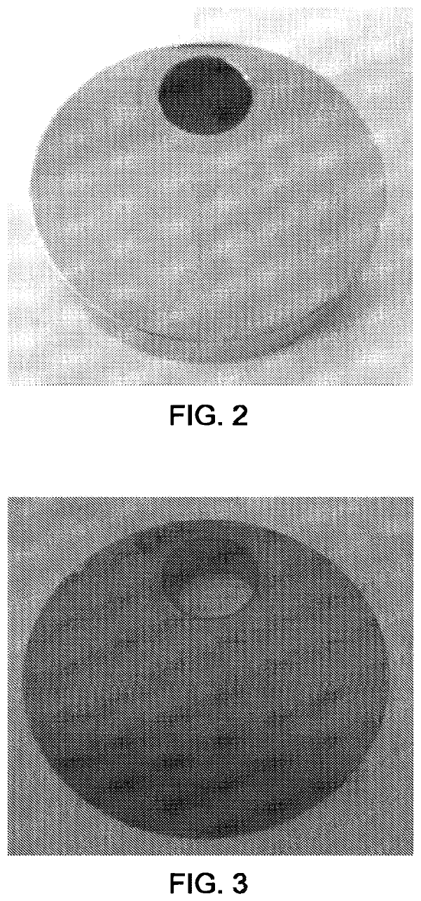

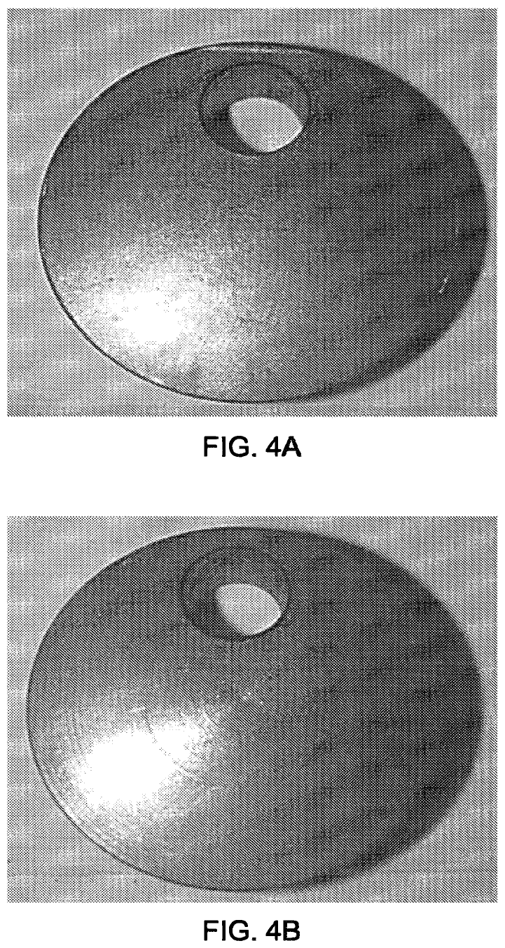

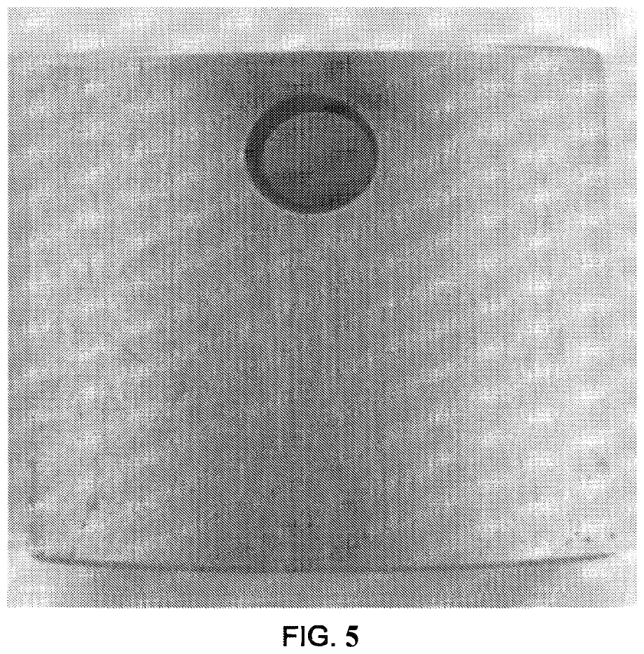

Accordingly, under high temperature conditions at extended periods of time the CII-THFA is able to enhance the activity of the corrosion inhibitor blend included in the treatment fluids, showing a mass rate loss (or corrosion loss) of 0.021 lb/ft², even up to 72 hours. It is noteworthy that the acceptable mass loss for metal surfaces in the oil and gas industry is 0.05 lb/ft² when exposure is expected for a period in excess of 3-6 hours. The CII-TFHA is able to enhance the corrosion inhibitors corrosion inhibitory action by coating onto the metal coupon. FIG. 2 shows a photographic image of a representative Inconel 825 nickel alloy coupon used in the above example before exposure to any of the treatment fluids. The coupon in FIG. 2 is silver and polished, having a clean surface. FIG. 3 shows a photographic image of the Inconel 825 nickel alloy coupon after exposure to TF2 for 24 hours; and FIGS. 4A and 4B show two photographic image of the same Inconel 825 nickel alloy coupon after exposure to TF3 for 72 hours. As seen, upon exposure to the corrosion inhibitor intensifier (CII-THFA), a coating forms on the surface of the coupon, as evidenced by the darker color in FIG. 3, and a fully black coating seen in FIGS. 4A and 4B.

Corrosion Testing on Carbon Steel: Each of TF1 and TF3 were exposed to a coupon of NT-95 carbon steel alloy over a period of time at 350° F. (176.7° C.) and the corrosion loss in pounds per square foot (lb/ft²) (converted to kilograms per square meter (kg/m²) below) was determined based on mass loss. The results are shown in Table 3 below.

TABLE 3

| | Exposure Time | Corrosion Loss |
|---|---|---|
| TF1 | 12 | 0.207 lb/ft² |
| | | (1.011 kg/m²) |
| TF3 | 72 | 0.248 lb/ft² |
| | | (1.211 kg/m²) |

The mass rate loss of TF3 (having CII-THFA therein) has a mass loss rate (corrosion rate) of greater than the generally acceptable 0.05 lb/ft², but may be satisfactory depending on the particular subterranean formation operation and duration of exposure. Further, the corrosion loss between the two tested treatment fluids is not extremely different, even though TF3 was exposed for 60 hours longer. FIG. 5 shows a photographic image of the NT-95 carbon steel alloy coupon after exposure to TF3 for 72 hours. As seen in FIG. 5, there was no visibly observed surface pitting, splintering, blistering, or excessive localized erosion. This observation again demonstrates the ability of the corrosion intensifier described herein (CII-THFA) to coat metal surfaces for enhancing corrosion inhibition synergistically with a corrosion inhibitor as described herein.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The disclosure illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A method comprising:
introducing a treatment fluid into a high temperature subterranean formation, the treatment fluid comprising:
an aqueous base fluid,
an acid,
a corrosion inhibitor, and
a corrosion inhibitor intensifier selected from the group consisting of tetrahydrofurfuryl alcohol, tetrahydrofurfuryl amine, and any combination thereof; and
inhibiting corrosion of a metal surface.

2. The method of claim 1, wherein the corrosion inhibitor intensifier enhances inhibitory corrosion action of the metal surface by the corrosion inhibitor compared to inhibitory corrosion action of the metal surface by the corrosion inhibitor in the absence of the corrosion inhibitor intensifier.

3. The method of claim 1, further comprising coating the corrosion inhibitor and the corrosion inhibitor intensifier on the metal surface.

4. The method of claim 1, wherein the high temperature subterranean formation has a temperature of from about 125° C. to about 204.4° C.

5. The method of claim 1, wherein the high temperature subterranean formation is a deep water wellbore having a subsea depth of about 1000 meters (m) to about 8000 m.

6. The method of claim 1, wherein the high temperature subterranean formation is a high pressure wellbore having a pressure of about 13.79 megapascals (MPa) to about 55.16 MPa.

7. The method of claim 1, wherein the acid is an organic acid.

8. The method of claim 1, wherein the corrosion inhibitor is selected from the group consisting of a quaternary ammonium compound, a sulfhydryl alkanoic acid, a bis-quaternary ammonium compound, an unsaturated carbonyl compound, 1-phenyl-1-ene-3-butanone, cinnamaldehyde, an unsaturated ether compound, 1-phenyl-3-methoxy-1-propene, an unsaturated alcohol, an acetylenic alcohol, a methyl butynol, methyl pentynol, hexynol, ethyl octynol, propargyl alcohol, benzylbutynol, ethynylcyclohexanol, a Mannich condensation product, a condensation product formed by reacting an aldehyde in the presence of an amide, a polysaccharide, inulin, a tannin, tannic acid, catechin, epicatechin, epigallocatechin, epicatechingallate, formamide, a carbonyl source, an iodide, a quaternary derivative of a heterocyclic nitrogen base, a quaternary derivative of a halomethylated aromatic compound, a terpene, an aromatic hydrocarbon, coffee, tobacco, any derivatives thereof, and any combination thereof.

9. The method of claim 1, wherein the acid is present in the treatment fluid in an amount of from about 5% to about 40% by volume of the treatment fluid.

10. The method of claim 1, wherein the corrosion inhibitor is present in the treatment fluid in an amount of about 0.5% to about 5% by volume of the treatment fluid.

11. The method of claim 1, wherein the corrosion inhibitor intensifier is present in the treatment fluid in an amount of about 1% to about 10% by volume of the treatment fluid.

12. A treatment fluid comprising:
an aqueous base fluid;
an acid;
a corrosion inhibitor; and
a corrosion inhibitor intensifier selected from the group consisting of tetrahydrofurfuryl alcohol, tetrahydrofurfuryl amine, and any combination thereof,
wherein the corrosion inhibitor intensifier enhances inhibitory corrosion action of a metal surface by the corrosion inhibitor at a high temperature of greater than about 125° C. compared to inhibitory corrosion action of the metal surface by the corrosion inhibitor in the absence of the corrosion inhibitor intensifier at the high temperature.

13. The method of claim 1, wherein the high temperature subterranean formation is a deep water wellbore having a subsea depth of about 1000 meters (m) to about 8000 m.

14. The method of claim 1, wherein the high temperature subterranean formation is a high pressure wellbore having a pressure of about 13.79 megapascals (MPa) to about 55.16 MPa.

15. The method of claim 1, wherein the acid is an organic acid.

16. The method of claim 1, wherein the corrosion inhibitor is selected from the group consisting of a quaternary ammonium compound, a sulfhydryl alkanoic acid, a bis-quaternary ammonium compound, an unsaturated carbonyl compound, 1-phenyl-1-ene-3-butanone, cinnamaldehyde, an unsaturated ether compound, 1-phenyl-3-methoxy-1-propene, an unsaturated alcohol, an acetylenic alcohol, a methyl butynol, methyl pentynol, hexynol, ethyl octynol, propargyl alcohol, benzylbutynol, ethynylcyclohexanol, a Mannich condensation product, a condensation product formed by reacting an aldehyde in the presence of an amide, a polysaccharide, inulin, a tannin, tannic acid, catechin, epicatechin, epigallocatechin, epicatechingallate, formamide, a carbonyl source, an iodide, a quaternary derivative of a heterocyclic nitrogen base, a quaternary derivative of a halomethylated aromatic compound, a terpene, an aromatic hydrocarbon, coffee, tobacco, any derivatives thereof, and any combination thereof.

17. The method of claim 1, wherein the acid is present in the treatment fluid in an amount of from about 5% to about 40% by volume of the treatment fluid.

18. The method of claim 1, wherein the corrosion inhibitor is present in the treatment fluid in an amount of about 0.5% to about 5% by volume of the treatment fluid.

19. The method of claim 1, wherein the corrosion inhibitor intensifier is present in the treatment fluid in an amount of about 1% to about 10% by volume of the treatment fluid.

20. A system comprising:
a tubular extending into a high temperature subterranean formation having a temperature of greater than about 125° C., and a pump fluidly coupled to the tubular, the tubular containing a treatment fluid comprising:
an aqueous base fluid,
an acid,
a corrosion inhibitor, and
a corrosion inhibitor intensifier selected from the group consisting of tetrahydrofurfuryl alcohol, tetrahydrofurfuryl amine, and any combination thereof,
wherein the corrosion inhibitor intensifier enhances inhibitory corrosion action of a metal surface by the corrosion inhibitor compared to inhibitory corrosion action of the metal surface by the corrosion inhibitor in the absence of the corrosion inhibitor intensifier.
